(19) United States
(12) Patent Application Publication
(10) Pub. No.: US 2004/0037312 A1
(43) Pub. Date: Feb. 26, 2004

(54) Method and communication network for operating a cross coding element

(76) Inventor: Stephen L. Spear, Skokie, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/226,793

(22) Filed: Aug. 23, 2002

(51) Int. Cl. H04J 3/16

(52) U.S. Cl. 370/465

(57) ABSTRACT

A method (400) and a communication network (110) for operating a cross coding element are described herein. The communication network (110) may detect a condition suggesting a change in encoded protocols between a first endpoint (240) and a second endpoint (250) such as, but not limited to, a call setup, an application requirement, and a handover associated with the first endpoint (240). The first endpoint (240) may operate in accordance with a first encoded protocol whereas the second endpoint (250) may operate in accordance with a second encoded protocol. The communication network (110) may communicate with a cross coding element (230) configured to convert a first encoded protocol signal from the first endpoint (240) to a second encoded signal. The first encoded signal may be encoded by the first encoded protocol, and the second encoded signal may be encoded by the second encoded protocol.

### TECHNICAL FIELD

The present disclosure relates generally to communication networks, and more particularly, to a method and a communication network for operating a cross coding element.

### BACKGROUND

A wireless communication system is a complex network of systems and elements. Typical systems and elements include (1) a radio link to mobile stations (e.g., a cellular telephone or a subscriber equipment used to access the wireless communication system), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a switching system, typically including a mobile switching center (MSC), to perform call processing within the system, and (5) a link to the land line, i.e., the public switch telephone network (PSTN) or the integrated services digital network (ISDN).

A base station subsystem (BSS), which typically includes one or more base station controllers and a plurality of base stations, provides all of the radio-related functions. The base station controller provides all the control functions and physical links between the switching system and the base stations. The base station controller is also a high-capacity switch that provides functions such as handover, cell configuration, and control of radio frequency (RF) power levels in the base stations.

The base station handles the radio interface to the mobile station. The base station includes the radio equipment (transceivers, antennas, amplifiers, etc.) needed to service each communication cell in the system. A group of base stations is controlled by a base station controller. Thus, the base station controller operates in conjunction with the base station as part of the base station subsystem to provide the mobile station with real-time voice, data, and multimedia services (e.g., a call).

After a call is initiated in an original cell, the mobile station may continue to scan the neighboring cells to determine if the signal from another cell becomes comparable to that of the original cell. When this happens, the switching system (e.g., via MSC and/or BSC) indicates to the mobile station that the call has entered a new cell's coverage area and that a handover can be initiated. The mobile station transmits a control message to either the MSC or the BSC, which states that the new cell is now strong and identifies the new cell. The MSC or the BSC initiates the handover by establishing a link to the mobile station through the new cell.

The two cells may operate in accordance with a variety of wireless communication standards. In particular, network elements providing communication services to the cells such as base station controllers and base stations may operate in accordance with different encoded protocols (i.e., codec, which is an abbreviation for coder/decoder). For example, the base station controllers and base stations providing communication services to the original cell may operate in accordance with an enhanced variable rate codec (EVRC) whereas the base station controllers and base stations providing communication services to the new cell may operate in accordance with a full rate codec. Thus, multiple transcoders may be used to convert a voice signal of a mobile station when it moves from the original cell to the new cell. However, such use of multiple transcoders may reduce the quality of the voice signal from the mobile station because of the inherent non-linearity of voice codecs. In particular, the quality of the voice signal may deteriorate by converting the encoded voice signal to a non-linear pulse code modulation (PCM) signal. That is, the voice signal starts in the linear domain where it is sampled and compressed to go over the air in a low bit rate codec by a transcoder (i.e., an encoded voice signal). The encoded voice signal is recovered and again enters the non-linear domain when it is converted to the non-linear PCM signal, which in turn, is routed to another transcoder. The non-linear PCM signal is sampled and compressed into a new packet using a difference voice codec, which is sent over the air and converted back to the linear domain as the original voice signal. Further, additional information (e.g., information associated with synchronization and lost frames) may be lost or erroneously introduced during the conversion to non-linear PCM such that the quality of the mobile signal may be decreased. For example, a transcoder may encode a non-linear PCM signal including an artificial insertion to substitute for a lost frame. As a result, the quality of the voice signal may be deteriorated by encoding the artificial insertion. In addition, the post-filter process of a transcoder may also contribute to the distortion from conversion to non-linear PCM. Moreover, the codec framing used by the transcoders may not be synchronized (i.e., framing misalignment). Thus, the quality of the voice signal may further deteriorate by decoding the encoded voice signal without synchronization of the codec framing.

Therefore, a need exist to operate a cross coding element to provide high quality voice and/or data transmission.

### BRIEF DESCRIPTION OF THE DRAWINGS

This disclosure will be described in terms of several embodiments to illustrate its broad teachings. Reference is also made to the attached drawings.

FIG. 1 is a block diagram representation of a wireless communication system.

FIGS. 2 and 3 are block diagram representations of a communication network.

FIGS. 4 and 5 are a visual representations of a handover.

FIG. 6 is a flow diagram illustrating a method for operating a cross coding element.

### DETAILED DESCRIPTION

A method and a communication network for operating a cross coding element are described herein. The communication network may detect a condition suggesting a change from a first encoded protocol to a second encoded protocol. The condition suggesting a change in encoded protocols may be, but is not limited to, a call setup, an application requirement, and a handover associated with a first endpoint. The first and second endpoints may be, but are not limited to, a mobile station, a gateway, a server, a fixed Internet Protocol (IP) phone, and a voice over IP (VoIP) endpoint. The first endpoint may operate in accordance with the first encoded protocol, and the second endpoint may operate in accordance with the second encoded protocol. Thus, the second endpoint may not support the first encoded protocol. The first and second encoded protocols may be codecs (i.e., coder/decoder for voice and/or video) such as, but not limited to, an enhanced variable rate codec (EVRC), a code excited linear prediction (CELP) codec, a selective mode vocoder (SMV) codec, a full rate codec, a half rate codec, an enhanced full rate codec, an adaptive multi-rate (AMR) codec, a time division multiple access (TDMA) based codec, and a voice over Internet protocol (VoIP) based codec. For example, the communication network may detect a handover of an endpoint from a cell and/or system operating in accordance with an EVRC to another cell and/or system operating in accordance with a full rate codec.

Upon detecting a condition suggesting a change from a first encoded protocol to a second encoded protocol, the communication network may communicate with a cross coding element configured to convert a first encoded signal from the first endpoint to a second encoded signal. In particular, the first encoded signal may be encoded by the first encoded protocol. For example, the first encoded signal may be a voice signal (e.g., speech) from a user of a mobile station that is encoded by the first encoded protocol. Accordingly, the cross coding element may convert the first encoded signal to the second encoded signal, which may be encoded by the second encoded protocol. As a result, the second endpoint may be operable to decode the second encoded signal and retrieve the original from the first endpoint.

A communication system is described herein in terms of several embodiments, and particularly, in terms of a wireless communication system operating in accordance with at least one of several standards. These standards include digital communication system protocols such as, but not limited to, the Global System for Mobile Communications (GSM), the IS-54 Time Division Multiple Access (TDMA) digital cellular system, the IS-134 TDMA digital cellular system, the IS-95 Code Division Multiple Access (CDMA) digital cellular system, CDMA 2000, the integrated Digital Enhanced Network (iDEN), the Personal Communications System (PCS), 3G, the Universal Mobile Telecommunications System (UMTS) and variations and evolutions of these protocols. The wireless communication system is a complex network of systems and elements. Typical systems and elements include (1) a radio link to mobile stations (e.g., a cellular telephone or a subscriber equipment used to access the wireless communication system), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a switching system, typically including a call server (e.g., a mobile switching center (MSC)) or a call agent, to perform call processing within the system, and (5) a link to the land line, i.e., the public switch telephone network (PSTN) or the integrated services digital network (ISDN).

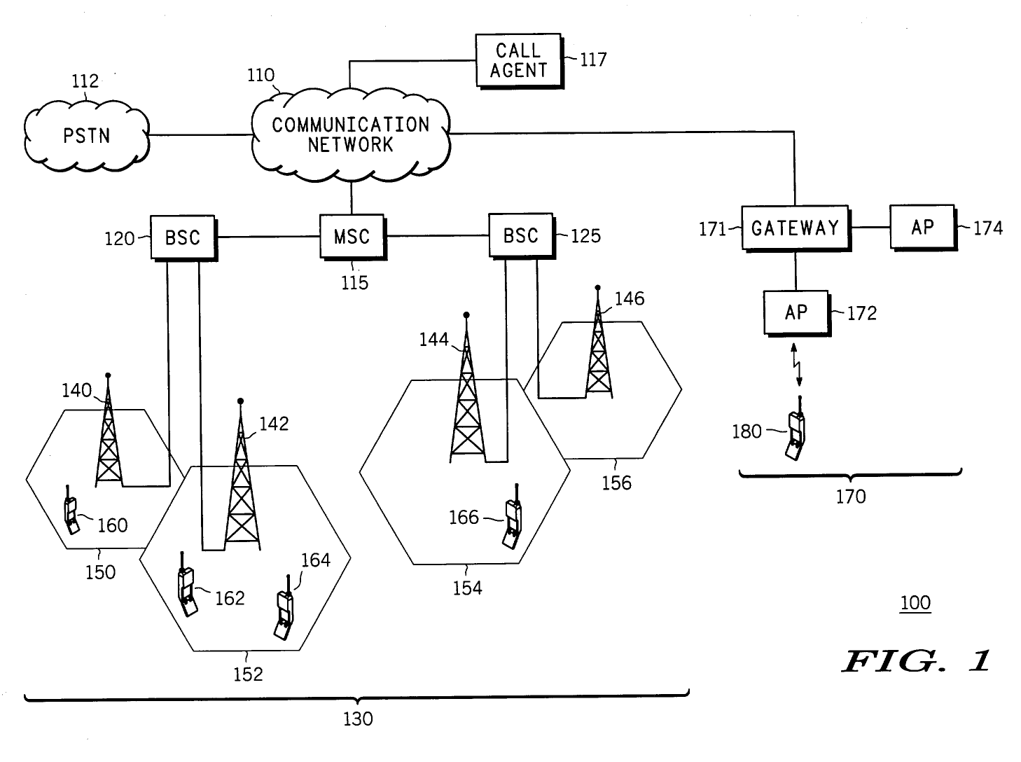

As shown in FIG. 1, a wireless communication system 100 includes a communication network 110 operatively coupled to the PSTN 112, and a switching system such as a call server (e.g., MSC 115) and a call agent 117. Alternatively, the PSTN 112, the MSC 115, and the call agent 117 may be integrated into the communication network 110. The communication system 100 also includes a plurality of base station controllers (BSC), generally shown as 120 and 125, servicing a total service area 130. As is known for such systems, each BSC 120 and 125 has associated therewith a plurality of base stations (BS), generally shown as 140, 142, 144, and 146, servicing communication cells, generally shown as 150, 152, 154, and 156, within the total service area 130. The BSCs 120 and 125, and base stations 140, 142, 144, and 146 are specified and operate in accordance with the applicable standard or standards for providing wireless communication services to mobile stations (MS), generally shown as 160, 162, 164, and 166, operating in communication cells 150, 152, 154, and 156, and each of these elements are commercially available from Motorola, Inc. of Schaumburg, Illinois.

Although the embodiments disclosed herein are particularly well suited for use with wide area communication systems (i.e., cellular systems), persons of ordinary skill in the art will readily appreciate that the teachings herein are in now way limited to those systems. On the contrary, persons of ordinary skill in the art will readily appreciate that the teachings can be employed with other communication systems such as short-range wireless communication systems. For example, the communication network 110 may be operatively coupled to a wireless LAN (WLAN) 170 via a gateway 171 and access points, generally shown as 172, 174. The communication network 110 may operate in accordance with, but not limited to, a Bluetooth based communication protocol and an Institute of Electrical and Electronic Engineers (IEEE) 802.11 based communication protocol to provide wireless communication services to a mobile station 180 via the access points 172, 174.

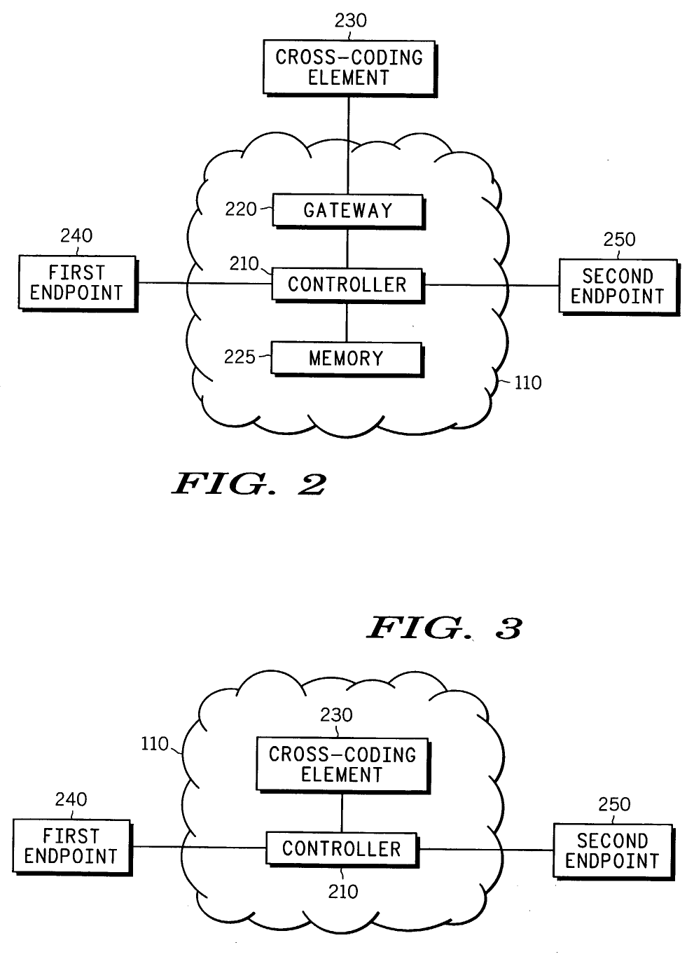

Referring to FIG. 2, the communication network 110 generally includes a controller 210, a gateway 220, and a memory 225. In particular, the communication network 110 may be, but is not limited to, an Internet Protocol (IP) network, an asynchronous transfer mode (ATM) network, and a circuit network. The controller 210 is operatively coupled to the gateway 220 to communicate with a cross coding element 230, a first endpoint 240, and a second endpoint 250. The controller 210 may be integrated into, but is not limited to, a mobility controller, a call server, and a call agent (one shown as 117 in FIG. 1). Further, the controller 210 is operatively coupled to the memory 225, which stores a program or a set of operating instructions for the controller 210. The controller 210 executes a program or the set of operating instructions such that the communication network 110 operates as described herein. The program of the set of operating instructions may be embodied in a computer-readable medium such as, but not limited to, paper, a programmable gate array, an application specific integrated circuit (ASIC), an erasable programmable read only memory (EPROM), a read only memory (ROM), a random access memory (RAM), a magnetic media, and an optical media.

The communication network 110 may be operatively coupled to the cross coding element 230. For example, the controller 210 may be operatively coupled to the cross coding element 230 via the gateway 220. Alternatively, the cross coding element 230 may be integrated into the communication network 110. For example, the communication network 110 may be an IP network such that the controller 210 may be operatively coupled to the cross coding element 230 without the gateway 220 as shown in FIG. 3.

The first and second endpoints 240, 250 may operate in accordance with different encoded protocols such that the first endpoint 240 may operate in accordance with a first encoded protocol whereas the second endpoint 250 may operate in accordance with a second encoded protocol. As noted above, the first and second endpoints 240, 250 may be, but are not limited to, mobile stations, gateways, servers, fixed Internet Protocol (IP) phones, and voice over IP (VoIP) endpoints. Referring back to FIG. 1, for example, the first and second endpoints 240, 250 may be associated with a cellular network such as mobile stations 160, 162, 164, 166. Alternatively, the first and second endpoints 240, 250 may be associated with the WLAN access points 172, 174 (e.g., the mobile station 180). The first and second endpoints 240, 250 may operate in accordance with difference encoded protocols. Further, an endpoint may move from one cell to another (e.g., from a first cell 150 to a second cell 152), from one wireless network to another (e.g., from a cellular network to a WLAN), and/or from one system to another (e.g., from a CDMA-based network to a GSM-based network or from a GSM-based network to an IP-based network). As a result, the communication network 110 may need to recognize when to convert a signal associated with an endpoint from one encoded protocol to another. The first and second encoded protocols may be, but are not limited to, an enhanced variable rate codec (EVRC), a code excited linear prediction (CELP) codec, selective mode vocoder (SMV) codec, a full rate codec, a half rate codec, an enhanced full rate codec, an adaptive multi-rate (AMR) codec, a time division multiple access (TDMA) based codec, and a voice over Internet protocol (VoIP) based codec. Because the first and second endpoints 240, 250 may operate in accordance to difference encoded protocols, the cross coding element 230 may be configured to convert a first encoded signal from the first endpoint 240 to a second encoded signal so that the second endpoint 250 may be operable to decode and retrieve the original signal encoded by the first endpoint 240 with the first encoded protocol.

A basic flow for operating the cross coding element 230 that may be applied with the communication network 110 shown in FIGS. 2 and 3 may start with the controller 210 detecting a condition suggesting a change in encoded protocols. The condition suggesting a change in encoded protocols may be, but is not limited to, a call setup, an application requirement, and a handover. As noted above, the controller 210 may be a call server or a call agent such that the controller 210 may detect a condition suggesting a change in encoded protocols during negotiation or renegotiation to determine an encoded protocol to use between the first and second endpoints 240, 250. When the preferred encoded protocols of the first and second endpoints 240, 250 are different, the controller 210 may need to communicate with the cross coding element 230 as described in detail below. Further, controller 210 may be communicate with the cross coding element 230 in response to an application requirement such as, but not limited to, primary application driver, enhanced error protection to cover bit errors and frame errors, compatibility and interoperability between applications, and terminal capability (e.g., capability for an over-the-air interface codec or a video codec).

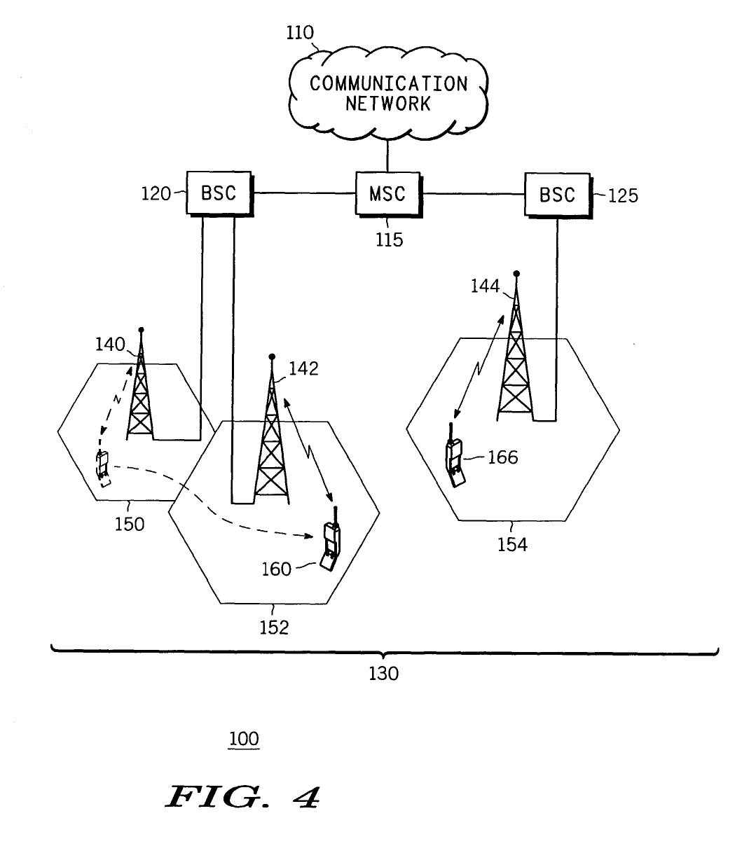

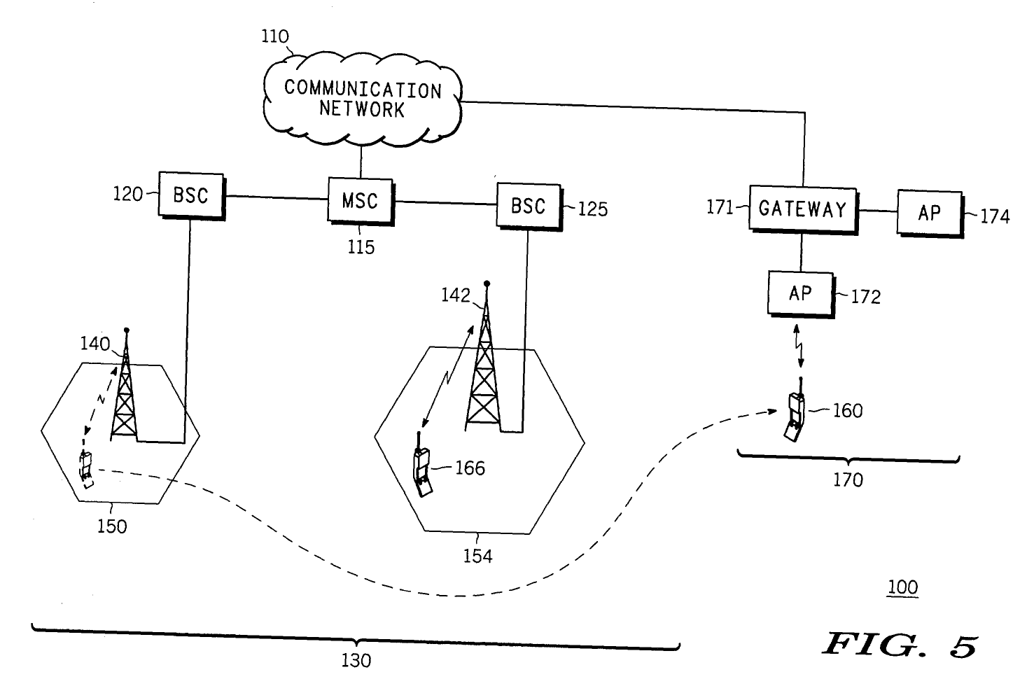

To illustrate the concept of detecting a condition suggesting a change in encoded protocols, the communication network 110 (e.g., via the controller 210) may detect a handover associated with the first endpoint 240. As used herein “handover” refers to an endpoint (e.g., a mobile station) being passed from one network element to another as the endpoint moves between cells and/or systems. Referring FIG. 4, a user of a first mobile station 160 may initiate the call in a first cell 150 to a user of a second mobile station 166 in a second cell 154. As noted above, a first base station 140 may provide communication service to the first cell 150 and a second base station 144 may provide service to the second cell 154. The communication network 110 (e.g., via a MSC 115) may negotiate between the first and second base stations 140, 144 to determine a preferred encoded protocol (i.e., audio and/or video codec) to use for encoding the voice signal of the call (i.e., a first encoded signal). The communication network 110 may have negotiated between the first and second mobile stations 160, 166 to operate in accordance with an EVRC (i.e., the preferred encoded protocol). When the first mobile station 160 moves into a third cell 152 serviced by a third base station 142, a handoff of the call may occur between the first base station 140 and the third base station 142. That is, the switching system (e.g., via either the BSC 120 or the MSC 115) may transfer the first mobile station 160 from the first base station 140 over to the third base station 142 (i.e., a handover) so that the third base station 142 may provide the first mobile station 160 with communication service. The mobile station 160 may need to operate in accordance with a different encoded protocol (e.g., an SMV codec). Accordingly, the communication network 110 may detect a condition suggesting a change in encoded protocols because the third base station 142 may operate in accordance with an encoded protocol that is different from the preferred encoded protocol (i.e., the encoded protocol determined at the call setup by the communication network 110 to use between the first and second base stations 140, 144). That is, the communication network 110 may detect a handover of the first encoded signal from the first base station 140 to the third base station 142. The first encoded signal may be encoded by the preferred encoded protocol of ERVC whereas the third base station 142 may need the first mobile station 160 to operate in accordance with the SMV codec.

Upon detection of a condition suggesting a change in encoded protocols, the communication network 110 may communicate with the cross coding element 230 to convert a first encoded signal from the first mobile station 160 to a second encoded signal. That is, the controller 210 may re-route the first encoded signal through the cross coding element 230. The first encoded signal may include, but is not limited to, a voice signal (e.g., speech) from a user of a mobile station (one shown as 160 in FIG. 1). For example, a voice signal from a mobile station operating in accordance with a CDMA based communication protocol may be encoded with an ERVC (i.e., a 8 kb/s codec with 160 bits every 20 msec). In another example, a voice signal from a mobile station operating in accordance with a GSM based communication protocol may be encoded with one of a full rate codec, a half rate codec, an enhanced full rate codec, and an adaptive multi-rate (AMR) codec. The controller 210 may route the first encoded signal to the cross coding element 230 to convert the first encoded signal to the second encoded signal, i.e., to generate the second encoded signal based on the voice signal within the first encoded signal. The second encoded signal may be encoded by a second encoded protocol such as, but not limited to, an enhanced variable rate codec (EVRC), a code excited linear prediction (CELP) codec, selective mode vocoder (SMV) codec, a full rate codec, a half rate codec, an enhanced full rate codec, an adaptive multi-rate (AMR) codec, and a time division multiple access (TDMA) based codec, and a voice over Internet protocol (VoIP) based codec.

For example, the cross coding element 230 may convert the voice signal within the first encoded signal to generate the second encoded signal based on a full rate codec in accordance with the GSM protocol. To reduce distortion, the cross coding element 230 may synchronize codec framing of the first and second encoded protocols to produce the second encoded signal. To illustrate this concept, the cross coding element 230 may synchronize codec framing of the EVRC and the full rate codec as mentioned in the above example. Further, the cross coding element may reduce degradation in quality of the original voice signal by converting the first encoded signal to a linear signal, and encode that linear signal with the second encoded protocol to generate the second encoded signal. To further reduce degradation in quality of the original voice signal, the controller 210 may transmit information associated with a lost frame to the second endpoint 250. That is, the cross coding element 230 may include information associated with a lost frame in the second encoded protocol signal so that artificial insertions are not interpreted as voice. Upon cross coding between the first and second encoded protocols, the cross coding element 230 transmits the second encoded signal to the second endpoint 250.

Alternatively, the mobile station 160 may move to a different network and/or system such as, but not limited to, from a cellular network to a WLAN, from a CDMA-based network to a GSM-based network, and from a GSM-based network to an IP-based network. For example, the mobile station 160 may move from a cellular network (i.e., providing the service area 130) to a WLAN 170 as shown in FIG. 5. Similar to the example above, the mobile station 160 may need to operate in accordance with a different encoded protocol in the WLAN 170. Accordingly, the communication network 110 may detect a condition suggesting a change in encoded protocols because the WLAN 170 may operate in accordance with an encoded protocol that is different from the preferred encoded protocol (i.e., the encoded protocol determined at the call setup by the communication network 110 to use in the cellular network). That is, the communication network 110 may detect a handover of a first encoded signal from the base station 140 to the access point 172. The first encoded signal may be encoded by the preferred encoded protocol whereas the network including the access point 172 may need the first mobile station 160 to operate in accordance with a different encoded protocol. Upon detection of a condition suggesting a change in encoded protocols, the communication network 110 may communicate with the cross coding element 230 to convert the first encoded signal used by the mobile station 160 in the service area 130 (i.e., a cellular network) to a second encoded signal used by the mobile station 160 in the wireless LAN 170.

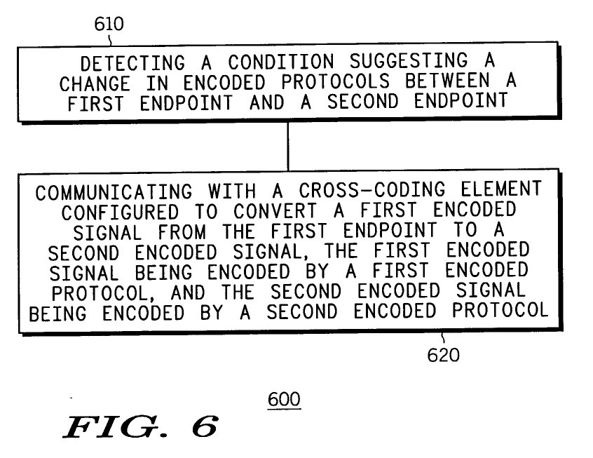

One possible implementation of the computer program executed by the communication network 110 is illustrated in FIGS. 2 and 3. Persons of ordinary skill in the art will appreciate that the computer program can be implemented in any of many different ways utilizing any of many different programming codes stored on any of many computer-readable mediums such as a volatile or nonvolatile memory or other mass storage device (e.g., a floppy disk, a compact disc (CD), and a digital versatile disc (DVD)). Thus, although a particular order of steps is illustrated in FIG. 6, persons of ordinary skill in the art will appreciate that these steps can be performed in other temporal sequences. Again, the flow chart 600 is merely provided as an example of one way to program the communication network 110 (i.e., the controller 210) to operate a cross coding element. The flow chart 600 begins at step 610, wherein the controller 210 may detect a condition suggesting a change in encoded protocols. For example, the controller 210 may detect an application requirement that requires a particular encoded protocol for operation. Other examples of a condition suggesting a change in encoded protocols may be, but is not limited to, a call setup and a handover associated with an endpoint. At step 620, the controller 210 may communicate with a cross coding element configured to convert a first encoded signal from a first endpoint to a second encoded signal. The first encoded signal may be encoded by the first encoded protocol whereas the second encoded signal may be encoded by the second encoded protocol. For example, the first encoded protocol may be an ERVC, and the second encoded protocol may be a full rate codec. Accordingly, the cross coding element may cross code the first encoded signal between the EVRC and the full rate codec to generate the second encoded signal.

Although the preferred embodiment uses voice codecs as an example, the cross coding element may be operable for video codecs and/or other information streams where a coding/decoding function occurs.

Many changes and modifications to the embodiments described herein could be made. The scope of some changes is discussed above. The scope of others will become apparent from the appended claims.

What is claimed:

1. In communication system, wherein a first endpoint is operable in accordance with a first encoded protocol, and a second endpoint is operable in accordance with a second encoded protocol, a method for operating a cross coding element, the method comprising:
detecting a condition suggesting a change in encoded protocols between the first and second endpoints; and
communicating with a cross coding element configured to convert a first encoded signal from the first endpoint to a second encoded signal, the first encoded signal being encoded by the first encoded protocol, and the second encoded signal being encoded by the second encoded protocol.

2. The method of claim 1, wherein the step of detecting a condition suggesting a change in encoded protocols between the first and second network endpoints comprises detecting one of a call setup, an application requirement, and a handover associated with the first endpoint.

3. The method of claim 1, wherein each of the first and second endpoints is one of a mobile station, a gateway, a server, a fixed Internet Protocol (IP) phone, and a voice over IP (VoIP) endpoint.

4. The method of claim 1, wherein the step of communicating with a cross coding element configured to convert a first encoded protocol signal from the first endpoint to a second encoded signal comprises communicating with the cross coding element via a gateway.

5. The method of claim 1, wherein the first encoded protocol is one of an enhanced variable rate codec (EVRC), a code excited linear prediction (CELP) codec, a selective mode vocoder (SMV) codec, a full rate codec, a half rate codec, an enhanced full rate codec, an adaptive multi-rate (AMR) codec, a time division multiple access (TDMA) based codec, and a voice over Internet protocol (VoIP) based codec.

6. The method of claim 1, wherein the second encoded protocol is one of an enhanced variable rate codec (EVRC), a code excited linear prediction (CELP) codec, a selective mode vocoder (SMV) codec, a full rate codec, a half rate codec, an enhanced full rate codec, an adaptive multi-rate (AMR) codec, a time division multiple access (TDMA) based codec, and a voice over Internet protocol (VoIP) based codec.

7. The method of claim 1, wherein the communication system operates in accordance with one of a code division multiple access (CDMA) based communication protocol, a global system for mobile (GSM) based communication protocol, an integrated digital enhanced network (iDEN) based communication protocol, and a voice over Internet protocol (VoIP) based communication protocol.

8. In communication system, wherein a first endpoint operating in accordance with a first encoded protocol, and a second endpoint operating in accordance with a second encoded protocol, a communication network for operating a cross coding element, the communication network comprising:
a memory;
a controller operatively coupled to the memory, the controller being programmed to detect a condition suggesting a change in encoded protocols between the first and second endpoint,
the controller being programmed to communicate with a cross coding element configured to convert a first encoded signal from the first endpoint to a second encoded signal, the first encoded signal being encoded by the first encoded protocol, and the second encoded signal being encoded by a second encoded protocol.

9. The communication network of claim 8, wherein the cross coding element is integrated into the communication network.

10. The communication network of claim 8, wherein the controller is integrated into one of a mobility controller, a call server, and a call agent.

11. The communication network of claim 8, wherein the condition suggesting a change in encoded protocols comprises one of a call setup, an application requirement, and a handover associated with the first endpoint.

12. The communication network of claim 8, wherein each of the first and second endpoints is one a mobile station, a gateway, a server, a fixed Internet Protocol (IP) phone, and a voice over IP (VoIP) endpoint.

13. The communication network of claim 8, wherein the first encoded protocol is one of an enhanced variable rate codec (EVRC), a code excited linear prediction (CELP) codec, a selective mode vocoder (SMV) codec, a full rate codec, a half rate codec, an enhanced full rate codec, an adaptive multi-rate (AMR) codec, a time division multiple access (TDMA) based codec, and a voice over Internet protocol (VoIP) based codec.

14. The communication network of claim 8, wherein the second encoded protocol is one of an enhanced variable rate codec (EVRC), a code excited linear prediction (CELP) codec, a selective mode vocoder (SMV) codec, a full rate codec, a half rate codec, an enhanced full rate codec, an adaptive multi-rate (AMR) codec, a time division multiple access (TDMA) based codec, and a voice over Internet protocol (VoIP) based codec.

15. The communication network of claim 8, wherein the communication network comprises one of an Internet Protocol (IP) network, an asynchronous transfer mode (ATM) network, and a circuit network.

16. The communication network of claim 8, wherein the communication network is operable in accordance with a code division multiple access (CDMA) based communication protocol, a global system for mobile (GSM) based communication protocol, an integrated digital enhanced network (iDEN) based communication protocol, and a voice over internet protocol (VoIP) based communication protocol.

17. In a communication system, wherein a first endpoint operating in accordance with a first encoded protocol and a second endpoint operating in accordance with a second encoded protocol, and wherein a controller operates in accordance to a computer program embodied on a computer-readable medium for operating a cross coding element, the computer program comprising:
a first routine that directs the controller to detect a condition suggesting a change in encoded protocols between the first and second endpoints; and
a second routine that directs the controller to communicate with a cross coding element configured to convert a first encoded signal from the first endpoint to a second encoded signal, the first encoded signal being encoded by the first encoded protocol and the second encoded signal being encoded by the second encoded protocol.

18. The computer program of claim 17, wherein the controller is integrated into one of a mobility controller, a call server, and a call agent.

19. The computer program of claim 17, wherein the first routine comprises a routine that directs the controller to detect one of a call setup, an application requirement, and a handover associated with the first endpoint.

20. The computer program of claim 17, wherein each of the first and second endpoints is one of a mobile station, a gateway, a server, a fixed Internet Protocol (IP) phone, and a voice over IP (VoIP) endpoint.

21. The computer program of claim 17, wherein the second routine comprises a routine that directs the controller to communicate with the cross coding element via a gateway.

22. The computer program of claim 17, wherein the first encoded protocol is one of an enhanced variable rate codec (EVRC), a code excited linear prediction (CELP) codec, a selective mode vocoder (SMV) codec, a full rate codec, a half rate codec, an enhanced full rate codec, an adaptive multi-rate (AMR) codec, a time division multiple access (TDMA) based codec, and a voice over Internet protocol (VoIP) based codec.

23. The computer program of claim 17, wherein the second encoded protocol is one of an enhanced variable rate codec (EVRC), a code excited linear prediction (CELP) codec, a selective mode vocoder (SMV) codec, a full rate codec, a half rate codec, an enhanced full rate codec, and adaptive multi-rate (AMR) codec, a time division multiple access (TDMA) based codec, and a voice over Internet protocol (VoIP) based codec.

24. The computer program of claim 17 operates in accordance with one of a code division multiple access (CDMA) based communication protocol, a global system for mobile (GSM) based communication protocol, an integrated digital enhanced network (iDEN) based communication protocol, and a voice over Internet protocol (VoIP) based communication protocol.

25. The computer program of claim 17, wherein the medium comprises one of paper, a programmable gate array, application specific integrated circuit, erasable programmable read only memory, read only memory, random access memory, magnetic media, and optical media.

26. In communication system, wherein a first endpoint is operable in accordance with a first encoded protocol, and a second endpoint is operable in accordance with a second encoded protocol, a method for operating a cross coding element, the method comprising:
detecting a condition suggesting a change in encoded protocols between the first and second endpoints within one of a call server and a call agent; and
communicating from one of the call server and the call agent to a means for converting a first encoded signal from the first endpoint to a second encoded signal, the first encoded signal being encoded by the first encoded protocol, and the second encoded signal being encoded by the second encoded protocol.

27. The method of claim 26, wherein the step of communicating from one of the call server and the call agent to a means for converting a first encoded signal from the first endpoint to a second encoded signal comprises communicating with the means for converting a first encoded signal from the first endpoint to a second encoded signal during renegotiation for an encoded protocol between the first and second endpoints in response to one of an application requirement and a handover.

28. The method of claim 26, wherein the step of communicating from one of the call server and the call agent to a means for converting a first encoded signal from the first endpoint to a second encoded signal comprises communicating from one of the call server and the call agent to one of a cross coding element and two transcoding elements.
